(19) United States
(12) Patent Application Publication
(10) Pub. No.: US 2007/0236404 A1
(43) Pub. Date: Oct. 11, 2007

(54) Integrated GPS antenna ground plane and telematics module

(76) Inventors: Chris R. Snider, Kokomo, IN (US); Paul J. Dobosz, Noblesville, IN (US)

Correspondence Address: DELPHI TECHNOLOGIES, INC., M/C 480-410-202, PO BOX 5052, TROY, MI, 48007, US

(21) Appl. No.: 11/398,349

(22) Filed: Apr. 5, 2006

(51) Int. Cl. H01Q 1/42

(52) U.S. Cl. 343/872; 343/702

(57) ABSTRACT

An electronic control unit has a cover that also serves as a ground plane for an antenna, such as a GPS antenna or other type of antenna. The antenna may be fastened directly to the cover, or mounted internally to the electronic control unit, printed circuit board, and protrude through an opening in the cover serving as the ground plane.

### TECHNICAL FIELD

This disclosure relates generally to mobile communications. More particularly, this disclosure relates to assembly of mobile communications systems.

### BACKGROUND OF THE DISCLOSURE

The vast majority of vehicles currently in use incorporate vehicle communication systems for receiving or transmitting signals. For example, vehicle audio systems provide information and entertainment to many motorists daily. These audio systems typically include an AM/FM radio receiver that receives radio frequency (RF) signals. These RF signals are then processed and rendered as audio output. A vehicle communication system may incorporate other functions, including, but not limited to, wireless voice and data communications, global positioning system (GPS) functionality, satellite-based digital audio radio (SDAR) services, keyless entry, and remote vehicle starting.

Consumer demand has increased for vehicle communication systems that extend the functionality of vehicles beyond transportation. For instance, a growing number of consumers expect their vehicles to provide entertainment, navigation assistance, and other non-traditional automotive functions. Telematics, for example, supplements the vehicle audio system with the functionality of wireless voice and data communications and a global positioning system (GPS). By combining these functions, the vehicle communication system can provide access to communications services external to the vehicle. For example, some services may allow users to purchase tickets to sporting and cultural events from the vehicle. Emergency services may allow the vehicle communication system to automatically notify response personnel in the event of an accident and provide such personnel with the location of the vehicle. In addition, users can have their vehicle doors remotely locked or unlocked from a call center. Stolen vehicles can also be tracked using vehicle telematics.

In a typical vehicular telematics system, a GPS receiver uses a GPS antenna to track GPS satellite signals to ascertain the location of the vehicle. Due to considerations associated with both vehicle design and GPS antenna performance, the GPS antenna may be located remotely from the vehicle electronic control unit (ECU), which controls various electronic systems of the vehicle. The GPS antenna assembly typically requires a metal or metallized ground plane surface, a connector with a cable, and some form of mounting hardware. The assembly is typically located in a vehicle location that has an unobstructed view of the sky so that the antenna can track the signal from the GPS satellites to ascertain the location of the vehicle. For example, the GPS antenna assembly may be located under the instrument panel dash pad, such that the antenna itself is under the windshield. Alternatively, the GPS antenna assembly may be located under the rear package shelf under the vehicle backlight or rear glass.

With this approach, the GPS antenna assembly must be securely attached to the mating vehicle component. In addition, a cable run must be provided to allow unobstructed connector assembly to a wire harness. Because the cable may be subjected to vibration, foam or a similar material is typically used to prevent the cable from rattling. Also, depending on the length of cable required and the number of connector terminations, some amplification is usually needed. Further, some connections may not be securely established, and may be lost at least intermittently.

### SUMMARY OF VARIOUS EMBODIMENTS

According to various example embodiments, an electronic control unit has a cover that also serves as a ground plane for an antenna, such as a GPS antenna. The antenna may be fastened directly to the cover, and the cable can be connected internally to the electronic control unit.

In one embodiment, an electronic control unit assembly includes an electronic control unit having a cover. An antenna is operatively coupled to the cover such that the cover forms a ground plane for the antenna.

Another embodiment is directed to an antenna arrangement including an antenna and a ground plane operatively coupled to the antenna. The antenna arrangement also includes an electronic control unit. The ground plane forms a cover of the electronic control unit.

In yet another embodiment, a vehicle communication system comprises a wireless communication device and an electronic control unit operatively coupled to the wireless communication device. A cover is mounted in a relatively fixed spatial relationship with the electronic control unit. An antenna is operatively coupled to the cover such that the cover forms a ground plane for the antenna.

Still another embodiment is directed to a vehicle telematics system including a housing. A telematics subsystem is located at least partially within the housing. An electronic control unit is operatively coupled to the telematics subsystem. A cover is mounted in a relatively fixed spatial relationship with the electronic control unit. An antenna is operatively coupled to the cover such that the cover forms a ground plane for the antenna.

Various embodiments may provide certain advantages. With the antenna connected directly to the electronic control unit, for example, there is no need for a separate mounting or for provisions for cable routing in the vehicle. Accordingly, the need for a separate metal plate for the ground plane may be eliminated. In addition, the cable length may be nearly eliminated, as is the interconnection from the antenna to a vehicle harness to an electronic control unit harness. Line loss may be reduced as a result, potentially reducing or obviating the need for amplification and bandpass filtering.

Additional objects, advantages, and features will become apparent from the following description and the claims that follow, considered in conjunction with the accompanying drawings.

### BRIEF DESCRIPTION OF THE DRAWINGS

FIG. 1 is a block diagram illustrating an example vehicle communication system according to an embodiment.

FIG. 2 is a block diagram illustrating an example vehicle telematics system according to another embodiment.

FIG. 3 is a perspective view illustrating an example electronic control unit assembly according to yet another embodiment.

FIG. 4 is an exploded perspective view illustrating a portion of the electronic control unit assembly of FIG. 3.

### DESCRIPTION OF VARIOUS EMBODIMENTS

According to various example embodiments, an electronic control unit has a cover or other portion of a metallic case that also serves as a ground plane for an antenna, such as a GPS antenna. The antenna may be fastened directly to the cover, and the cable can be connected internally to the electronic control unit.

In one embodiment, an electronic control unit assembly includes an electronic control unit having a cover. An antenna is operatively coupled both electrically and mechanically to the cover such that the cover forms a ground plane for the antenna. The electronic control unit assembly may be incorporated in a vehicle communication system, a vehicle telematics system, or a vehicle entertainment system.

With the antenna connected directly to the electronic control unit, for example, there is no need for a separate mounting or for provisions for cable routing in the vehicle. Accordingly, the need for a separate metal plate for the ground plane may be eliminated. In addition, the cable length may be nearly or completely eliminated if the antenna is directly placed on the circuit board with the ground plane as the antenna protrudes through the case, as is the interconnection from the antenna to a vehicle harness to an electronic control unit harness. Line loss may be reduced as a result, potentially reducing or obviating the need for amplification and bandpass filtering.

In the following description, numerous specific details are set forth in order to provide a thorough understanding of various embodiments of the present invention. It will be apparent to one skilled in the art that the present invention may be practiced without some or all of these specific details. In other instances, well known components and process steps have not been described in detail in order to avoid unnecessarily obscuring the present invention.

Referring now to the drawings, FIG. 1 illustrates an example vehicle communication system 100 according to one embodiment. A housing 102 is formed from any of a variety of materials, including but not limited to, for example, die cast metal. The housing 102 may be implemented, for example, as an open case having a lid. One or more partitions within the housing 102 may divide the interior volume of the housing 102 into compartments. One such compartment may be sized and configured to accommodate a wireless communication device 104, such as a wireless telephony module. The wireless communication device 104 is in electrical communication with a navigational electronic control unit (ECU) 106 accommodated within a second compartment. The ECU 106 contains telematics or vehicle entertainment systems and circuits. The ECU 106 may be programmable to implement, for example, localization options or premium features as desired. The wireless communication device 104 is also in electrical communication with an antenna 108, which receives and/or transmits signals for use by the wireless communication device 104, the ECU 106, and potentially other systems not shown in FIG. 1.

The ECU 106 may be implemented as a module having a cover formed, for example, of sheet metal. The cover may be formed from other conductive materials, such as die cast metal or metallized plastic. The ECU 106 may be located proximate the top of the center stack of the instrument panel or under a package shelf proximate a rear portion of the vehicle. With the ECU 106 thus located, the cover of the ECU 106 can also function as a ground plane for the antenna 108. According to an embodiment, the antenna 108 is fastened directly to the cover. A cable 110 may be connected internally to the ECU 106, if necessary.

Fastening the antenna 108 directly to the ECU 106 may avoid the need for a separate mounting and for provisions for cable routing in the vehicle. The need for a separate metal plate serving as the ground plane of the antenna 108 can also be avoided. As a result, the cable length may be substantially reduced or completely eliminated. In addition, interconnections between the antenna 108, vehicle harness, and ECU harness may also be eliminated. Due to the resulting reduced line loss, the need for amplification and band pass filtering may be eliminated as well.

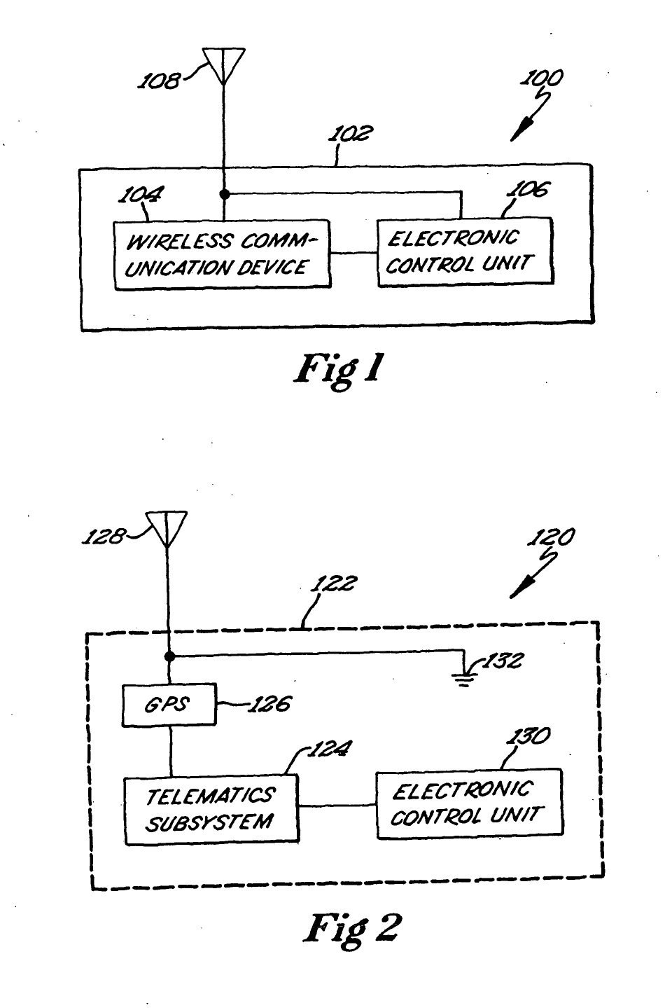

FIG. 2 illustrates an example vehicle telematics system 120 according to another embodiment. The vehicle telematics system 120 includes a housing 122 that may be formed from die cast metal or any of a variety of other materials. The housing 122 may be implemented as an open case having a lid. The open case defines an internal volume that may be divided into compartments by one or more partitions within the housing 122. One compartment may be sized and configured to accommodate a telematics subsystem 124 implemented, for example, on a printed circuit board (PCB). The telematics subsystem 124 may incorporate a variety of functional subsystems, such as, for example, a global positioning system (GPS) receiver, a microprocessor, one or more memory modules, and the like. A GPS module 126 may be located in the same compartment as the telematics subsystem 124 or in a different compartment. The GPS module 126 receives a GPS signal from a network of satellites via a GPS antenna 128. The telematics subsystem 124 may also be in electrical communication with the GPS antenna 128 or with one or more other antennas. Such antennas may be used to receive and/or transmit signals for use by the telematics subsystem 124 and potentially other systems not shown in FIG. 2. The telematics subsystem 124 is in electrical communication with a telematics electronic control unit (ECU) 130 accommodated within another compartment. The ECU 130 contains telematics or vehicle entertainment systems and circuits that may interact with other vehicle systems. The ECU 130 may be programmable to implement, for example, localization options or premium features as desired.

The ECU 130 may be implemented as a module having a cover formed, for example, of sheet metal. The cover may be formed from other conductive materials, such as die cast metal or metallized plastic. The cover is mounted in a relatively fixed spatial relationship with the ECU 130. The ECU 130 may be located proximate the top of the center stack of the instrument panel or under a package shelf proximate a rear portion of the vehicle. With the ECU 130 thus located, the cover of the ECU 130 can also function as a ground plane 132 for the GPS antenna 128 or any antenna requiring a ground plane, including, but not limited to, an antenna for a wireless telephony device or a satellite radio. According to an embodiment, the GPS antenna 128 is fastened directly to the cover.

Fastening the GPS antenna 128 directly to the ECU 130 may avoid the need for a separate mounting and for provisions for cable routing in the vehicle. The need for a separate metal plate serving as the ground plane of the GPS antenna 128 can also be avoided. As a result, the cable length may be substantially reduced. In addition, interconnections between the GPS antenna 128, vehicle harness, and ECU harness may also be eliminated. Due to the resulting reduced line loss, the need for amplification and band pass filtering may be eliminated as well.

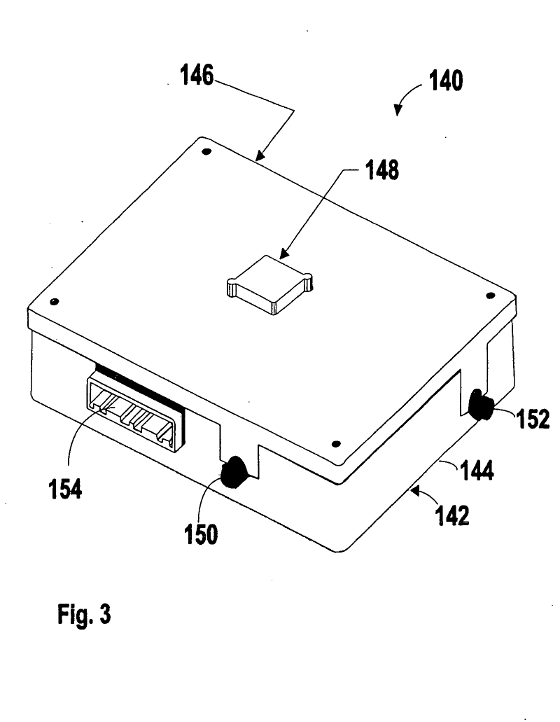

FIG. 3 is a perspective view illustrating an example electronic control unit (ECU) assembly 140. The ECU assembly 140 may be located proximate the top of the center stack of the instrument panel or under a package shelf proximate a rear portion of the vehicle. The ECU assembly 140 includes a housing 142. As shown in FIG. 3, the housing 142 is implemented as an open case 144 having a sheet metal cover 146. The sheet metal cover 146 is mounted in a relatively fixed spatial relationship with the housing 142. A GPS module (not shown) may be located in the same housing 142 as the ECU assembly 140. The GPS module receives a GPS signal from a network of satellites via a GPS antenna 148. The ECU assembly 140 may be in electrical communication with other components via ports 150, 152, and 154.

According to the embodiment shown in FIG. 3, the GPS antenna 148 is mounted in a relatively fixed spatial relationship to the sheet metal cover 146 of the ECU assembly 140. In this way, the sheet metal cover 146 can function as a ground plane for the GPS antenna 148. The GPS antenna 148 may be fastened directly to the sheet metal cover 146, or may be secured to the sheet metal cover 146 through one or more intervening structures or protrude through the sheet metal cover 146, provided that there is an electrical connection between the GPS antenna 148 and the sheet metal cover 146.

Fastening the GPS antenna 128 directly to the sheet metal cover 146 may avoid the need for a separate mounting and for provisions for cable routing in the vehicle. The need for a separate metal plate serving as the ground plane of the GPS antenna 148 can also be avoided. As a result, the cable length may be substantially reduced. In addition, interconnections between the GPS antenna 148, vehicle harness, and ECU harness may also be eliminated. Due to the resulting reduced line loss, the need for amplification and band pass filtering may be eliminated as well.

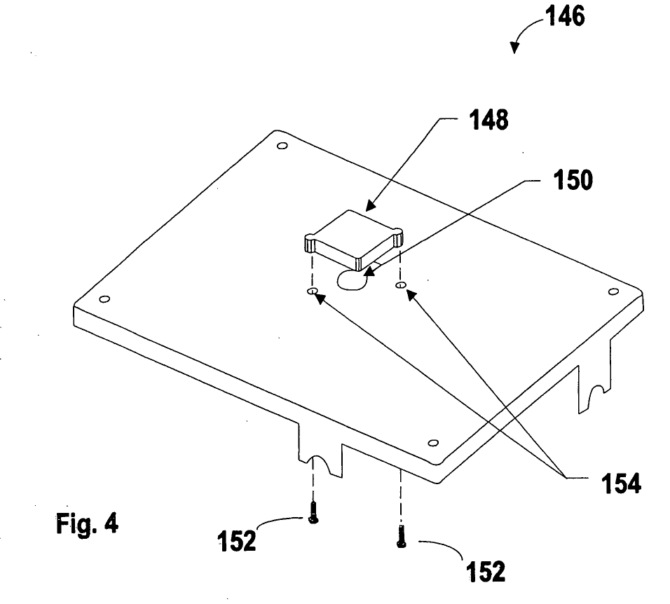

FIG. 4 is an exploded perspective view illustrating the sheet metal cover 146 of FIG. 3. The sheet metal cover 146 is formed from a material suitable for providing a ground plane for the GPS antenna 148. An aperture 150 is formed through the sheet metal cover 146 at a location at which the GPS antenna 148 is mounted. In this way, electrical conductors (not shown) extending from the GPS antenna 148 can be routed to circuitry inside the ECU assembly 140 of FIG. 3. The GPS antenna 148 is attached to the sheet metal cover 146, for example, using screws 152 installed through screw holes 154 formed in the sheet metal cover 146.

As demonstrated by the foregoing discussion, various embodiments may provide certain advantages. For instance, with the antenna connected directly to the electronic control unit, there is no need for a separate mounting or for provisions for cable routing in the vehicle. Accordingly, the need for a separate metal plate for the ground plane may be eliminated. In addition, the cable length may be nearly eliminated, as is the interconnection from the antenna to a vehicle harness to an electronic control unit harness. Line loss may be reduced as a result, potentially reducing or obviating the need for amplification and bandpass filtering.

It will be understood by those skilled in the art that various modifications and improvements may be made without departing from the spirit and scope of the disclosed embodiments. The scope of protection afforded is to be determined solely by the claims and by the breadth of interpretation allowed by law.

What is claimed is:

1. An electronic control unit assembly comprising:
an electronic control unit having a cover; and
an antenna operatively coupled to the cover such that the cover forms a ground plane for the antenna.

2. The electronic control unit assembly of claim 1, wherein the cover is formed from a material selected from the group consisting of sheet metal, die cast metal, and metallized plastic.

3. The electronic control unit assembly of claim 1, wherein the antenna comprises a global positioning system (GPS) antenna.

4. The electronic control unit assembly of claim 1, wherein the antenna is mounted in a relatively fixed spatial relationship with the cover.

5. The electronic control unit assembly of claim 1, further comprising a circuit board defining an aperture, wherein the antenna protrudes through the aperture.

6. The electronic control unit assembly of claim 1, wherein the antenna is mounted on the cover.

7. An antenna arrangement comprising:
an antenna;
a ground plane operatively coupled to the antenna; and
an electronic control unit,
wherein the ground plane forms a cover of the electronic control unit.

8. The antenna arrangement of claim 7, wherein the cover is formed from a material selected from the group consisting of sheet metal, die cast metal, and metallized plastic.

9. The antenna arrangement of claim 7, wherein the antenna comprises a global positioning system (GPS) antenna.

10. The antenna arrangement of claim 7, wherein the antenna is mounted in a relatively fixed spatial relationship with the ground plane.

11. The antenna arrangement of claim 7, wherein the antenna is mounted on the ground plane.

12. A vehicle communication system comprising:
a wireless communication device;
an electronic control unit operatively coupled to the wireless communication device;
a cover mounted in a relatively fixed spatial relationship with the electronic control unit; and
an antenna operatively coupled to the cover such that the cover forms a ground plane for the antenna.

13. The vehicle communication system of claim 12, wherein the cover is formed from sheet metal.

14. The vehicle communication system of claim 12, wherein the antenna comprises a global positioning system (GPS) antenna.

15. The vehicle communication system of claim 12, wherein the antenna is mounted in a relatively fixed spatial relationship with the cover.

16. The vehicle communication system of claim 12, wherein the antenna is mounted on the cover.

17. A vehicle telematics system comprising:
a housing;
a telematics subsystem located at least partially within the housing;
an electronic control unit operatively coupled to the telematics subsystem;
a cover mounted in a relatively fixed spatial relationship with the electronic control unit; and
an antenna operatively coupled to the cover such that the cover forms a ground plane for the antenna.

18. The vehicle telematics system of claim 17, wherein the telematics subsystem comprises an electronic commerce subsystem.

19. The vehicle telematics system of claim 17, wherein the telematics subsystem comprises an emergency services subsystem.

20. The vehicle telematics system of claim 17, wherein the telematics subsystem comprises a vehicle remote control subsystem.

21. The vehicle telematics system of claim 20, wherein the vehicle remote control subsystem is configured to enable operation of a vehicle lock from a location remote to the vehicle.

22. The vehicle telematics system of claim 17, wherein the telematics subsystem comprises a vehicle tracking subsystem.

23. The vehicle telematics system of claim 17, wherein the cover is formed from sheet metal.

24. The vehicle telematics system of claim 17, wherein the antenna comprises a global positioning system (GPS) antenna.

25. The vehicle telematics system of claim 17, wherein the antenna is mounted in a relatively fixed spatial relationship with the cover.

26. The vehicle telematics system of claim 17, wherein the antenna is mounted on the cover.
